(19) United States
(12) Patent Application Publication
(10) Pub. No.: US 2008/0078501 A1
(43) Pub. Date: Apr. 3, 2008

(54) Method of joining a porous silicon carbide body and a silicon carbide-silicon composite

(75) Inventors: Jianhui Li, Nishiokitama-gun (JP); Takahiro Tabei, Nishiokitama-gun (JP)

Correspondence Address: FOLEY AND LARDNER LLP;SUITE 500, 3000 K STREET NW, WASHINGTON, DC, 20007, US

(73) Assignee: COVALENT MATERIALS CORPORATION

(21) Appl. No.: 11/902,302

(22) Filed: Sep. 20, 2007

(30) Foreign Application Priority Data
Sep. 28, 2006 (JP) 2006-265203
Sep. 12, 2007 (JP) 2007-236058

(51) Int. Cl. C09J 5/06

(52) U.S. Cl. 156/305

(57) ABSTRACT

A method of joining a silicon carbide body and a silicon carbide-silicon composite, including a step of applying an adhesive paste 3 consisting of silicon carbide powder and a binder component to either or both of a porous silicon carbide body 1 and a silicon carbide-silicon composite 2 formed by impregnating a silicon carbide body with silicon such that said porous silicon carbide body and said silicon carbide-silicon composite are caused to adhere to each other, a step of causing a volatile constituent to evaporate from said adhesive paste 3 such that a porous silicon carbide adhesion layer 3 is formed between said porous silicon carbide body and said silicon carbide-silicon composite, and a step of causing the silicon in said silicon carbide-silicon composite to permeate said adhesion layer 3 through a heat treatment after the previous step such that said adhesion layer 3 is densified.

### BACKGROUND OF THE INVENTION

1. Field of the Invention

The present invention relates to a method of joining a porous silicon carbide (hereinafter referred to as “SiC”) body and a silicon carbide-silicon (hereinafter referred to as “SiC—Si”) composite and in particular, relates to a method of joining a porous silicon carbide (SiC) body and a silicon carbide-silicon (SiC—Si) composite formed by impregnating a silicon carbide (SiC) body with silicon (hereinafter referred to as “Si”).

2. Description of the Related Art

Since SiC ceramics have excellent properties such as heat resistance, abrasion resistance and chemical resistance, it is widely used for a semiconductor-related component such as a jig for production of semiconductors.

In case a jig made of the SiC ceramics for production of semiconductors or the like has a large size shape or complex shape, such a jig can be difficult to produce all at once into the form of an integral jig. In such case, one jig is produced by preparing a plurality of components made of SiC ceramics beforehand and then these respective components are joined together.

As a method for joining the SiC ceramics, for example, it is disclosed by the Examined Patent Publication (Kokoku) No. 5-79630.

In this method, a porous SiC body is first overlaid on top of an SiC body by way of a binder composed of thermosetting resin containing SiC micro-particles. Further, a silicon (Si) sheet is overlaid on top of said porous SiC body.

Then, the entire body is heated up to the temperature at which said silicon is melted and the temperature is maintained for a predetermined period of time. The molten silicon is infiltrated into the pores of said porous SiC body, and caused to react with carbon generated as a result of carbonization of the thermosetting resin of said binder so that an SiC layer is formed at a joining portion for joining.

It is disclosed by the joining method shown in the Examined Patent Publication (Kokoku) No. 5-79630 that the impregnated molten silicon reacts with the carbon in the binder by way of the porous SiC body. As a result, a reaction process of SiC at the joining layer cannot be sufficiently controlled, and a sintered SiC layer can be formed unevenly as a joining layer. Because of this unevenness, there has been a problem such as a lack of mechanical strength of the joining portion. Further, there has been a problem such that Si is left on the top surface of the porous SiC body.

### SUMMARY OF THE INVENTION

The present invention is made to solve the above-mentioned technical problems and it is an object of the invention to provide a method of joining a porous SiC body and an SiC—Si composite which improves the mechanical strength of a joined body, controls the permeation length of Si into a porous SiC body to be joined and restrains exudation of surplus Si on the surface of a porous SiC body.

The present invention was made to accomplish the above discussed object, and a method of joining a porous SiC body and an SiC—Si composite in accordance with the present invention is characterized in that it includes a step of applying an adhesive paste consisting of silicon carbide powder and a binder component to either or both of a porous SiC body and an SiC—Si composite formed by impregnating a silicon carbide body with silicon (Si) such that said porous SiC body and said SiC—Si composite are caused to adhere to each other, a step of causing a volatile constituent to evaporate from said adhesive paste such that a porous SiC adhesion layer is formed between said porous SiC body and said SiC—Si composite, and a step of causing the silicon (Si) in said SiC—Si composite to permeate said adhesion layer through a heat treatment after the previous step such that said adhesion layer is densified.

Thus, the method of joining a porous SiC body and an SiC—Si composite of the present invention is, as its subject matter, to form a dense joining layer by causing molten silicon (Si) in said SiC—Si composite to permeate the porous SiC adhesion layer by a capillary phenomenon. Therefore, it is possible to improve the mechanical strength of a joined body (joining layer) and control the permeation length of silicon (Si) into a porous SiC body to be joined, and restrain exudation of surplus Si on the surface of a porous SiC body.

It is to be noted that the SiC—Si composite formed by impregnating an SiC body with silicon (Si) is understood to mean a composite of silicon carbide (SiC) and silicon (Si) with a porosity of not more than 0.3 vol. % which has been obtained by sintering an SiC body formed of silicon carbide powder and carbon powder or a binder component having residual carbon formed by sintering, and impregnating interstices of the sintered SiC body with molten silicon (Si) so that silicon carbide (SiC) is formed by a reaction of carbon and silicon (Si).

Here, it is preferable that a silicon portion in the SiC—Si composite formed by impregnating the SiC body with silicon (Si) has an average diameter greater than an average pore diameter of said adhesion layer and smaller than an average pore diameter of said porous SiC body.

That is, it is preferable that the average pore diameter of said porous SiC body, the average diameter of an Si portion in said SiC—Si composite and the average pore diameter of the porous SiC adhesion layer have the following relationship; the average pore diameter of the porous SiC adhesion layer<the average diameter of the Si portion in the SiC—Si composite<the average pore diameter of the porous SiC body.

It is to be noted that the average pore diameter is understood to mean a value which is calculated by conducting a measurement of pore size distribution by mercury intrusion porosimeter. And, the average diameter of the Si portion in said SiC—Si composite is understood to mean an SiC inter-particle distance in a sintered SiC body. More specifically, the average diameter of the Si portion in the sintered SiC body is obtained, after the Si portion in the aforementioned sintered body are removed by use of hydrofluoric nitric acid, by conducting the above measurement and calculation for said SiC inter-particle distance in the remaining SiC body (JIS R 1655: Method of measuring pore size distribution by mercury intrusion method for fine ceramics).

Thus, the average pore diameter of the porous SiC adhesion layer is set to be the smallest in order to absorb the silicon (Si) in the SiC—Si composite by a capillary phenomenon to form a dense joining layer.

Further, the average diameter of the Si portion in said SiC—Si composite is set to be smaller than the average pore diameter of the porous SiC body in order to prevent the silicon melted during the heat treatment from permeating the porous SiC body.

It is undesirable that the average diameter of the Si portion in the SiC—Si composite is larger than the average pore diameter of the porous SiC body, because in such case, molten Si prepared during the heat treatment permeates the porous SiC body or the surface layer thereof via the joining layer to cause a loss of the function of the porous SiC body.

Further, it is preferable that said heat treatment is performed at a temperature of 1450° C. or more, under a reduced pressure, for 60 minutes or more.

It is undesirable that said heat treatment is performed at a temperature of less than 1450° C. and a heat treatment time of less than 60 minutes, because in such case, Si is not allowed to permeate the adhesion layer, a porosity or the like is left to prevent a dense body from being formed, and it can cause a leakage from the joining portion to lessen the mechanical strength thereof.

According to the present invention, it is possible to obtain a method of joining a porous SiC body and an SiC—Si composite which improves the mechanical strength of a joined body and controls the permeation length of Si into a porous SiC body to be joined, and restrains exudation of surplus Si on the surface of porous SiC body.

### BRIEF DESCRIPTION OF THE DRAWING

FIG. 1A and FIG. 1B are conceptual diagrams illustrating the joining method of a porous SiC body and an SiC—Si composite in accordance with the present invention; and

FIG. 2 is a schematic configuration diagram illustrating the filter that is a joined body of a porous SiC body and an SiC—Si composite.

### DESCRIPTION OF THE PREFFERED EMBODIMENTS

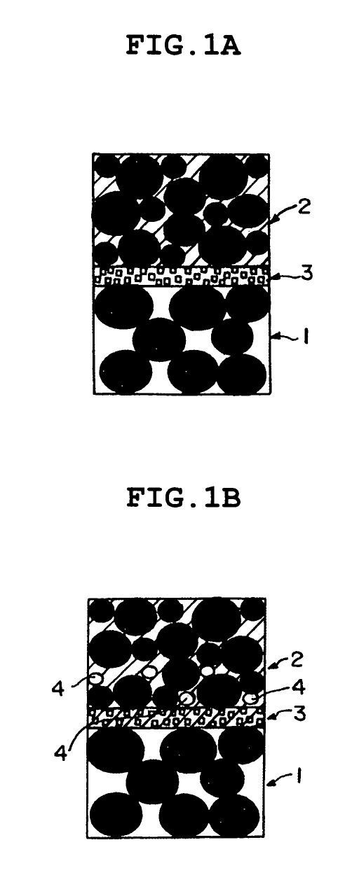

Hereinafter, the embodiments of the present invention will be described with reference to FIG. 1A and FIG. 1B.

A joining method in accordance with the present invention is the method for joining a porous SiC body 1 and an SiC—Si composite 2 as shown in FIG. 1A, and is characterized in that a porous SiC adhesion layer 3 is formed between the porous SiC body 1 and the SiC—Si composite 2, and molten Si in the SiC—Si composite 2 is caused to permeate the porous SiC adhesion layer 3 by a capillary phenomenon so as form a dense joining layer.

It is to be noted that in FIG. 1A, the black circles denote SiC particles, the'shaded area denotes Si, the squares denote SiC particles in the adhesion layer 3 and the blank areas denote pores schematically.

For the joining method of the present invention, in order to form a dense joining layer by causing molten Si in the SiC—Si composite 2 to permeate the porous SiC adhesion layer 3 by a capillary phenomenon as mentioned above, the average pore diameter of the porous SiC body, the average diameter of the Si portion in the SiC—Si composite and the average pore diameter of the porous SiC adhesion layer need to have the following relationship.

That is, the porous SiC body 1, the SiC—Si composite 2 and the porous SiC adhesion layer 3(adhesive paste consisting of SiC powder) to be used for this joining method need to have a relationship of the average pore diameter of the porous SiC adhesion layer<the average diameter of the Si portion in the SiC—Si composite<the average pore diameter of the porous SiC body.

Thus, the average pore diameter of porous SiC adhesion layer 3 is set to be the smallest in order to absorb the Si in the SiC—Si composite by a capillary phenomenon to make the adhesion layer 3 dense.

In addition, the average diameter of the silicon (Si) portion in the SiC—Si composite 2 is set to be smaller than the average pore diameter of the porous SiC body 1 in order not to cause the molten Si to permeate the porous SiC body 1 during a heat treatment.

It is to be noted that it is undesirable that the average pore diameter of the Si portion in the SiC—Si composite 2 is larger than the average pore diameter of the porous SiC body 1, because in such case, the molten Si will be caused to permeate the inside of the porous SiC body or the surface layer thereof via the joining layer 3 during the heat treatment to cause a loss of the function of the porous SiC body 1.

For carrying out the joining method of the present invention, the porous SiC body 1, the SiC—Si composite 2 and the porous SiC adhesion layer 3 (adhesive paste consisting of SiC powder) are prepared so as to maintain the above-mentioned relationship.

Then, the adhesive paste 3 consisting of SiC powder is applied to either or both of the porous SiC body 1 and the SiC—Si composite 2. The thin-porous SiC adhesion layer 3 is formed by causing a volatile consistent to evaporate from said adhesive paste 3 so as to cure the adhesive paste 3 consisting of SiC powder. In this manner, the porous SiC body 1 and the SiC—Si composite 2 become a temporarily-joined body (See FIG. 1A).

Thereafter, a heat treatment for the temporarily-joined body is performed at high temperature so that the Si in the SiC—Si composite 2 is melted and a small amount of the molten Si is caused to permeate the porous SiC adhesion layer 3 by a capillary phenomenon. In this manner, the dense joining layer is formed (FIG. 1B).

It is preferable that said heat treatment is performed under a condition of a temperature of 1450° C. or more, under a reduced pressure of a few Pa and a heat treatment time of 60 minutes or more. It is undesirable that said heat treatment is performed at a temperature of less than 1450° C. and a heat treatment time of less than 60 minutes, because in such case, silicon (Si) will not caused to permeate the adhesion layer and a porosity or the like is left with the result that a dense body will not be formed, and it can cause a leakage from the joining portion whereas the mechanical strength is reduced.

In the present invention, silicon (Si) is impregnated into the porous SiC adhesion layer and the mechanical strength of the joined body can be improved (See FIG. 1B).

Further, by using a body to be joined having the above mentioned predetermined relationship of pore diameters, a permeation of silicon (Si) into the porous SiC body to be joined can be restrained and exudation of surplus Si on the surface of the porous SiC body can be restrained.

It is to be noted that due to the outflow of Si from the SiC—Si composite, a small amount of microscopic pore 4 is formed in the area of a joined interface of the SiC—Si composite as shown in FIG. 1B. However, since those pores are discrete closed pores and they exist only in a narrow range of the joined interface area, a leakage of gas and liquid from the SiC—Si composite 2 will not occur. In addition, it does not affect a joining strength.

Next, particular examples and evaluation results of the present invention will be described.

### EXAMPLE 1

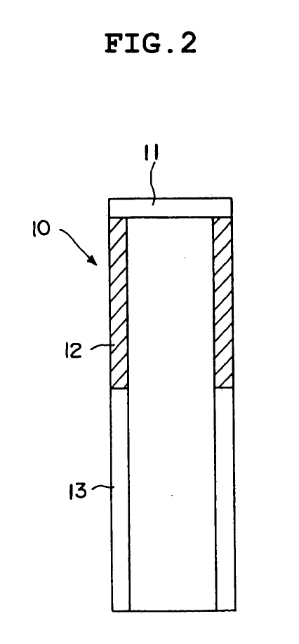

Filter 10 shown in FIG. 2 was produced by joining the porous silicon carbide (SiC) body and the silicon carbide-silicon (SiC—Si) composite. In FIG. 2, the character 11 denotes a cap section made of the SiC—Si composite, the character 12 denotes a cylindrical filter section made of the porous SiC body to be joined with said cap section 11, and the character 13 denotes a filter body made of the SiC—Si composite to be joined with said filter section.

Firstly, the cap section 11 and the filter body 13 were produced out of the SiC—Si composite.

For said filter, said filter body was prepared by mixing 25% by weight of SiC raw powder of 100 μm, 25% by weight of SiC raw powder of 40 μm and 50% by weight of SiC raw powder of 4 μm, 3% by weight (outer percentage) of carbon powder, 13% by weight (outer percentage) of binder and 10% by weight (outer percentage) of water and granulating the mixture to be followed by extrusion molding.

Then, said molded filter body was cured at a temperature of about 200° C., calcined at 1500° C. to 1800° C. in a nitrogen atmosphere under a reduced pressure, processed into a cylindrical shape having predetermined dimensions (the outer diameter of 20 mm, the inner diameter of 16 mm, and the length of 100 mm).

Molten silicon (Si) was impregnated into said calcined filter body in an inert gas atmosphere of nitrogen, at a temperature of 1430° C. to 1500° C. At this time, the average diameter of the Si portion (SiC inter-particle distance) in the filter body (SiC—Si composite) was 0.4 μm.

Subsequently, said cap section was prepared by mixing SiC raw powder consisting of a weight ratio of SiC raw powder of 100 μm to SiC raw powder of 10 μm being 60:40 with 4% by weight (outer percentage) of carbon powder and 11% by weight (outer percentage) of binder, causing the mixture to be granulated and molding the granules by a cold isostatic pressing (CIP) method.

Then, the thus molded cap section was cured at a temperature of about 200° C., calcined at 1500° C. to 1800° C. and processed into a disc-shape form having predetermined dimensions (the diameter of 19 mm, the thickness of 3 mm).

Subsequently, molten silicon (Si) was impregnated into said calcined cap section in an inert gas atmosphere of nitrogen, at a temperature of 1430° C. to 1500° C. At this time, an average diameter of the Si portion (SiC inter-particle distance) in the cap section (SiC—Si composite) was 7 μm.

Secondly, the filter section was prepared out of the porous SiC body.

For the filter, a filter section was prepared by mixing 30% by weight of SiC raw powder of 100 μm and 70% by weight of SiC raw powder of 10 μm, 14% by weight (outer-percentage) of Si powder of 5 μm and 11% by weight (outer percentage) of binder, granulating the mixture, and molding the granules by a cold isostatic pressing (CIP) method.

The thus prepared filter section was temporally calcined at a temperature of 1500° C. to 1700° C. and processed and formed into a cylindrical shape having predetermined dimensions (the outer diameter of 19 mm, the inner diameter of 16 mm, and the length of 40 mm) . Then, said temporally-calcined filter section was further calcined fully at a temperature of 2200° C. so that it became a filter section made of porous SiC. At this time, an average pore diameter of the porous SiC body was 9 μm.

Next, a method of joining a cap section (SiC—Si composite) 11 and a filter body (SiC—Si composite) 13 with a filter section (porous SiC body) 12 will be explained.

Firstly, for only the surface layer of the joining surface of the cap section (SiC—Si composite) 11 and the filter body (SiC—Si composite) 13, the Si thereof was etched by hydrofluoric nitric acid. It is to make them hard to get peeled off when adhering mentioned below.

Further, an adhesive paste for joining was produced. This adhesive paste was produced by mixing 30% by weight of SiC powder of 100 μm and 70% by weight of SiC powder of 4 μm, 20% by weight (outer percentage) of binder and 7% by weight (outer percentage) of propylene glycol, degassing the mixture, adding 0.8% by weight (outer percentage) of hydrochloric acid, and then kneading the degassed mixture into an adhesive paste.

This adhesive paste was applied to the adhesion surfaces of the cap section (SiC—Si composite) 11 and the filter body (SiC—Si composite) 13.

Then, the filter section (porous SiC body) 12 was crimped to the cap section (SiC—Si composite) 11. Further, the filter section (porous SiC body) 12 was crimped to the filter body (SiC—Si composite) 13. The resultant joined body was cured in microwave oven by causing a volatile consistent to evaporate from said adhesive paste 3. It is to be noted that an average pore diameter of the adhesion layer (porous SiC) after the curing was 0.03 μm.

Thereafter, said joined body was heat treated at a temperature of 1470° C. under a reduced pressure of a few Pa for 3.5 hours, molten-silicon (Si) in the cap section (SiC—Si composite) and in the filter body (SiC—Si composite) was caused to permeate the adhesion layer (porous SiC) to be joined, thus completing the production of the filter (Example 1).

And, a same type of filter was produced by a conventional silicon (Si) impregnation-method. The procedure of this production method is as described below.

In the same manner as Example 1, a filter body, a cap section, a filter section and an adhesive paste were prepared. Then, a porous SiC body was overlaid on the top surface of the SiC body by way of a binder composed of thermosetting resin containing SiC micro-particles. Further, an Si sheet was overlaid on the top surface of the porous SiC body. Then, the entire body was heated up to a temperature at which said silicon (Si) is melted and the temperature was maintained for a predetermined period of time. And said silicon (Si) was infiltrated into pores of said porous SiC body and was caused to react with carbon (C) generated by carbonization of the thermosetting resin of said binder so that an SiC layer was formed at a joining portion, where joining was done.

For the Example 1 and the conventional example, the Si permeation into the adhesion layer, the permeation length of silicon (Si) into the porous SiC body, and the exudation (blow-off) of Si on the porous SiC body were verified. The result is shown in Table 1.

As can be observed from Table 1, the Example 1 was preferable since Si was caused to permeate the adhesion layer, and no permeation-free area was confirmed. In addition, Si was not caused to permeate the porous SiC body and silicon exudation (blow-off) was not confirmed.

On the other hand, for the conventional example, even though there was no permeation-free area of Si into the adhesion layer, Si was excessively caused to permeate the filter section (porous body) and the permeation length varied greatly in the range 4 to 40 mm. In addition, a large area and a large amount of Si exudation (blow-off) was observed.

TABLE 1

| | | Permeation | | | |
|---|---|---|---|---|---|
| | Si permeation | length of Si | | | |
| | into the | into the | | Si | |
| Joining method | adhesion layer | porous body | | exudation | Judgment |
| Example 1 | No | 0 | mm | Small | ◯ |
| | permeation-free | | | area, | |
| | area | | | small | |
| | | | | amount | |
| Conventional | No | 4 to 40 | mm | Large | X |
| Example | permeation-free | | | area, | |
| | area | | | large | |
| | | | | amount | |

(◯: good, X: bad)

Next, in a same manner as the cap section in the Example 1, a column-shaped SiC—Si composite having a width of 4 mm, a thickness of 3 mm and a length of 40 mm was produced. And in the same manner as the filter section in the Example 1, a column-shaped porous SiC body having a width of 4 mm, a thickness of 3 mm and a length of 40 mm was produced.

Then, in a same manner as the Example 1, said column-shaped SiC—Si composite and said column-shaped porous SiC body were joined by using the adhesive paste shown in Example 1 (Example 2).

On the other hand, in a same manner as said Example 2, a column-shaped SiC—Si composite having a width of 4 mm, a thickness of 3 mm and a length of 40 mm and a column-shaped porous SiC body having a width of 4 mm, a thickness of 3 mm and a length of 40 mm were produced, and a joined body was obtained by a conventional silicon impregnation-method (Comparative Example 1).

Then, the strength (the three point flexural strength) of the joining portion was verified. The result is shown in Table 2. As can be observed from Table 2, the strength of the joining portion was significantly increased. It is to be noted in the Example 2 that this flexural strength test shows that breakage started from the substrate of the porous SiC body other than the joining portion thereof. It suggests that Si was caused to fully permeate the adhesion layer, and the strength of joining portion is more than that of substrate of the porous SiC body.

TABLE 2

| | | Strength | | Strength ratio |
|---|---|---|---|---|
| | | of the | Strength of | of the joining |
| | | porous | the joining | portion to the |
| Joining method | Detail | body | portion | porous body |
| Example 2 | Good | 20.3 MPa | 30.0 MPa | 148% |
| | condition in | | | |
| | the joining | | | |
| | layer | | | |
| Comparative | Permeation- | 22.9 MPa | 17.8 MPa | 78% |
| Example 1 | free area | | | |
| | observed in | | | |
| | the joining | | | |
| | layer | | | |

Next, column-shaped SiC—Si composites (having a width of 20 mm, a thickness of 10 mm and a length of 40 mm) were produced in a same manner as the filter body and the cap section in the Example 1. Then, SiC—Si composites having the average diameter of a silicon (Si) portion (having an SiC inter-particle distance) D1 of 7 μm and 0.4 μm were obtained.

And, column-shaped porous SiC bodies (having a width of 20 mm, a thickness of 10 mm and a length of 10 mm) were produced in a same manner as the Example 1. By controlling the particle size of SiC raw powder, the compounding ratio and the calcinations temperature, porous SiC bodies having an average pore diameter D2 of 0.2 μm to 9 μm were obtained.

For an adhesive paste, the same paste as in the Example 1 (having a pore diameter of 0.03 μm) was used.

Then, by combining the results shown in Table 3, the permeation length of Si into the porous SiC body and the permeating condition were verified. It is to be noted that in the Example 3 to 5 and the Comparative Example 2 to 4, the heat treatment was performed under the same condition as the Example 1.

The result is shown in Table 3.

TABLE 3

| | | | | Per- | | |
|---|---|---|---|---|---|---|
| | | | | meation | | |
| | | | | length into | Permeation | |
| | D1 | D2 | D1/ | the porous | into the | |
| | (μm) | (μm) | D2 | body | porous body | Judgment |
| Comparative | 7 | 0.2 | 35 | >2 mm | Permeated | X |
| Example 2 | | | | | inside of the | |
| | | | | | porous body | |
| Comparative | 7 | 0.6 | 12 | >2 mm | Permeated | X |
| Example 3 | | | | | inside of the | |
| | | | | | porous body | |
| Comparative | 7 | 3 | 2.3 | 1 mm | Permeated | X |
| Example 4 | | | | | surface layer | |
| | | | | | of the porous | |
| | | | | | body | |
| Example 3 | 7 | 9 | 0.8 | 0 mm | No | ⊚ |
| | | | | | permeation | |
| Example 4 | 0.4 | 0.6 | 0.7 | <1 mm | Permeated | ◯ |
| | | | | | inside of the | |
| | | | | | porous body | |
| Example 5 | 0.4 | 3 | 0.13 | 0 mm | No | ⊚ |
| | | | | | permeation | |

(⊚: very good, ◯: good, X: bad)

As can be observed from Table 3, it is preferable to have a relationship such as the average diameter of the Si portion in the SiC—Si composite (SiC inter-particle distance)<the average pore diameter of the porous SiC body, since permeation into the inside of porous SiC body can be well restrained.

Then, the heat-treatment condition was verified. Tube-shaped SiC—Si composites (having an outer diameter of 20 mm, an inner diameter of 16 mm and a length of 100 mm) with the average diameter of the Si portion (SiC inter-particle distance) D1 being 7 μm were produced in the same manner as the cap section in the Example 1. Further, Tube-shaped porous SiC bodies (having an outer diameter of 20 mm, an inner diameter of 16 mm and a length of 100 mm) with the pore diameter being 9 μm were produced in the same manner as the filter section in the Example 1. The same paste as the Example 1 (having a pore diameter of 0.03 μm) was used as an adhesive paste, and heat treatments were performed under the conditions shown in Table 4 (Example 6, 7 and Comparative Example 5 and 6).

TABLE 4

| | Temperature | Time | Condition of the | |
|---|---|---|---|---|
| | (° C.) | (minute) | adhesion layer | Judgment |
| Comparative | 1430 | 15 | Permeation-free | X |
| Example 5 | | | area observed | |
| Comparative | 1430 | 45 | Permeation-free | X |
| Example 6 | | | area observed | |
| Example 6 | 1450 | 60 | No | ◯ |
| | | | permeation-free | |
| | | | area | |
| Example 7 | 1490 | 150 | No | ◯ |
| | | | permeation-free | |
| | | | area | |

(◯: good, X: bad)

It was confirmed that it is undesirable to have a heat-treatment condition such as a temperature of less than 1450° C. and a heat treatment time of less than 60 minutes because, in such case, a permeation-free area of silicon (Si) and a porosity or the like were left at the adhesion layer so no dense body was formed with the result that it can cause a leakage from the joining portion and a reduction in the mechanical strength.

The present invention can be widely used as a method of joining a porous SiC body and an SiC—Si composite. For example, it is widely used in the manufacturing industry of semiconductor-related components or the like such as a jig for production of semiconductors.

1. A method of joining a porous silicon carbide (SiC) body and a silicon carbide-silicon (SiC—Si) composite comprising the steps of:
(a) applying an adhesive paste consisting of silicon carbide (SiC) powder and a binder component to either or both of a porous silicon carbide (SiC) body and a silicon carbide-silicon (SiC—Si) composite formed by impregnating a silicon carbide (SiC) body with silicon (Si) such that said porous silicon carbide (SiC) body and said silicon carbide-silicon (SiC—Si) composite are caused to adhere to each other;
(b) causing a volatile constituent to evaporate from said adhesive paste such that a porous silicon carbide (SiC) adhesion layer is formed between said porous silicon carbide (SiC) body and said silicon carbide-silicon (SiC—Si) composite; and
(c) causing the silicon in said silicon carbide-silicon (SiC—Si) composite to permeate said adhesion layer through a heat treatment after the step (b) such that said adhesion layer is densified.

2. The method of joining a porous silicon carbide (SiC) body and a silicon carbide-silicon (SiC—Si) composite according to claim 1, wherein there is a relationship that a silicon portion in said silicon carbide-silicon (SiC—Si) composite formed by impregnating the silicon carbide (SiC) body with silicon (Si) has an average diameter greater than an average pore diameter of said adhesion layer and smaller than an average pore diameter of said porous silicon carbide (SiC) body.

3. The method of joining a porous silicon carbide (SiC) body and a silicon carbide-silicon (SiC—Si) composite according to claim 1, wherein said heat treatment is performed under a condition of a temperature of 1450° C. or more, under a reduced pressure and a heat treatment time of 60 minutes or more.

4. The method of joining a porous silicon carbide (SiC) body and a silicon carbide-silicon (SiC—Si) composite according to claim 2, wherein said heat treatment is performed under a condition of a temperature of 1450° C. or more, under a reduced pressure and a heat treatment time of 60 minutes or more.
